(19) United States
(12) Patent Application Publication
(10) Pub. No.: US 2002/0091645 A1
(43) Pub. Date: Jul. 11, 2002

(54) Software licensing system

(76) Inventor: Kagemoto Tohyama, Tokyo (JP)

Correspondence Address: Carl Schaukowitch, RADER, FISHMAN & GRAUER, PLLC, Suite 501, 1233 20th Street, NW, Washington, DC, 20036, US

(21) Appl. No.: 10/016,106

(22) Filed: Dec. 17, 2001

(30) Foreign Application Priority Data
Dec. 20, 2000 (JP) 2000-387929

(51) Int. Cl. H04K 1/00; H04L 9/00; G06F 17/60

(52) U.S. Cl. 705/59

(57) ABSTRACT

There is provided a licensing system comprising an application information database into which a license management server machine stores a license menu containing a function, a term and a number of times and the like for which usage may be approved with respect to software to be usage-approved. A user terminal is capable of accessing the application information database via an Internet network. Further, when the license management server machine creates a pass containing the function, the term and the number of times of use and the like based on agreement/selection made at the user terminal and sends this pass to the user terminal, the user terminal sends out, to the software that is the subject of the usage-approval, a run-approval or run-disapproval command data in accordance with information on the function, the term and the number of times of use and the like included in the received pass and becomes able to use the software in a manner in conformity with the content of the usage-approval in the pass. Therefore, according to the licensing system of the present invention, a software license granting technique is provided in which a range of software licensing choices is expanded so that various user needs can be met even with the same single software, and unlawful copying of the software that is approved for use by the user can be eliminated.

### BACKGROUND OF THE INVENTION

1. Field of the Invention

The present invention pertains to a software license granting technique performed between terminals that are mutually connectable via a communications line.

2. Description of the Related Art

In software which is used on personal computers, cellular telephones, PDAs and other such portable information communications terminals, a method has become common in which a blanket license is granted to a user for the software in its entirety, as seen in examples in which the above hardware have the software pre-installed, or in which software is stored on a CD-ROM or other such recording medium and sold as a package. According to this licensing method, the user who has received the license can use, forever, all aspects of the software that is stored in the hardware or in the recording medium.

However, on the other hand, it is a fact that much doubt has been voiced by users about the unreasonableness of the way the blanket license works, namely that unnecessary functions are more or less forcibly incorporated into the license as the subject thereof, and there is no choice but to buy these, even when only the basic functions the basic functions would be sufficient. Further, from the point of view of the software supplier, too, particularly in the case of the blanket license in the package-type sale, there was a problem that it was easy to copy the software illegally, and this problem is yet unresolved.

Incidentally, in recent years ASP (Application Service Provider) service has received much attention. ASP service is a service in which the user obtains a right to use the service on the condition of a payment of a proportionate fee, the user then exercises the right to use the service and makes an ASP server execute an intended data processing and then data resulting from the processing is received at a user terminal via a communications line, in what can be called a software functionality outsourcing service. Therefore, this service is qualitatively different from the license on the software itself. Further, by using the ASP service, it is possible to receive the data resulting from the desired processing by means of the same software, without having to buy the desired software. Also, the software is not copied illegally without restriction, thus making it reasonable from the perspective of the supplier as well. However, the processing content is restricted to the range of processing that can be executed by the ASP server, so the there is a problem that a variety of user needs may not necessarily be met completely, and also a problem that in the case where the data volume of the data resulting from the processing is great, a long duration of time is necessary to receive the data through the communications line. In conclusion, considering these problems, the more practical approach is for the user to receive the software license and own the software himself, and use the software on his own hardware.

### SUMMARY OF THE INVENTION

The present invention was developed to solve problems, such as those mentioned above, which are inherent in conventional software license and ASP service. That is, an object of the present invention is to provide a software license granting technique which is based on software licensing but capable of expanding the range of choices relating thereto, and which can meet various user needs even with the same single software.

Further, an another object of the present invention is to provide a software license granting technique capable of eliminating illegal copying of the software for which approval of usage was granted to the user.

According to the present invention, in order to achieve the above objects, there is provided a software licensing system comprising: a licensing terminal for storing a license menu which includes a function, a term and a number of times and the like, for which usage may be approved with respect to a software for which usage approval is to be given; and a user terminal capable of accessing the license menu via a communications line; wherein when the licensing terminal creates and sends to the user terminal a pass containing the function, the term and the number of times and the like for which usage is to be approved based on an agreement/selection by the user terminal, the user terminal then sends, to the software for which the usage approval is to be given, a run-approval or a run-disapproval command data according to information on the function, the term and the number of times of use and the like contained in the received pass, and the user terminal then becomes able to use the software in a manner in conformity with the content of the usage approval in the pass created by the license terminal.

According to this licensing system, the licensing terminal stores the license menu which includes the function, the term and the number of times and the like for which the usage may be approved with respect to the software for which the usage approval is to be given, and the user terminal is capable of accessing the license menu via the communications line. Therefore, at the user terminal it is possible to agree to/select from the license menu only the necessary function, term and number of times of use and the like with respect the software for which the usage approval is to be given. The content which is included in the license menu and for which usage may be approved can be broadly divided into two categories of “content elements” and “time elements,” and the licensing terminal can combine these freely to enable setting of various license conditions; therefore, the user's range of choices is expanded. For the content elements, it is possible to set such things as: either the entirety of the software which is the subject of the usage approval, or just the basic functions thereof; other functions provided to the software; an upgraded version of the software; diagrams of parts that can be used with the software; and contents such as image data including designs, picture patterns and the like, or music data. Further, for the time elements it is possible to set such things as, for example: “perpetual”, i.e. usability with no time restrictions; a calendar period which specifies a period on a calendar during which usage may be allowed; a total duration of time of use, which specifies a total duration of time for which usage may be allowed; a total number of times of use, which specifies a total number of times for which usage may be allowed.

Further, when the agreement/selection is made by means of the user terminal, the licensing terminal creates and sends to the user terminal the pass containing the function, the term and the number of times and the like for which usage is to be approved, the user terminal sends to the software the run-approval or run-disapproval command data according to information on the function, the term and the number of times of use and the like contained in the received pass, and the user terminal can use the software in question in a manner in conformity with the content of the usage approval in the pass created by the license terminal. Therefore, for the user, it is possible to have software that has been customized to the user's own needs and freely use the software at the user terminal. Further, for the supplier, even if the user to whom the approval of usage has been granted tries to run the software at another user terminal, there does not exist the pass for sending the run-approval or run-disapproval command data for that software in that other user terminal; therefore, copying of the software at that other user terminal can be prevented.

The licensing system such as described above can be reduced to practice according to various embodiments. For example, the above licensing system can be applied both in the case of software which is stored in a CD-ROM or other such recording medium and installed into the user terminal, and in the case of software which is downloaded to the user system via the communications line and then installed. Further, when the above licensing system is to be implemented, it is possible to install software having a usage restriction into the user terminal first, and then implement the licensing system thereafter to release the usage restriction with respect to those items for which approval has been given; and it is also possible to implement the licensing system first, and then install the software in the user terminal with respect to only those items which have been approved. Additionally, the above licensing system can be applied to software that can be run on a terminal device such as a personal computer, a PDA, a cellular telephone or the like which is capable of communicating with the licensing terminal and thus serves as the “user terminal”.

Further, according to the present invention, in order to achieve the above objects, there are provided a software licensing terminal, a user terminal, a computer program and a recording medium, which can also be applied in the licensing system described above. As the licensing terminal, according to the present invention, there is provided a software licensing terminal comprising: a means for storing the license menu which includes the function, the term and the number of times of use and the like for which usage may be approved with respect to the software for usage approval is to be given; a means for creating the pass containing the function, the term and the number of times and the like for which usage is approved based on the agreement/selection by the user terminal that is connected via the communications line; and a means for sending the pass to the user terminal via the communications line.

Further, the computer program and the recording medium according to the present invention are constructed as a computer program and computer readable recording medium for storing the program, which computer program executes the following by means of a control means of the licensing terminal which can connect via the communications line to the user terminal that uses the software for which usage approval has been given and which stores the license menu containing the function, the term and the number of times and the like for which usage may be approved for the software: processing (a) being processing for sending to the user terminal a license menu that pertains to the software; processing (b) being processing for receiving agreement/selection data that contains the function, the term and the number of times and the like that the user terminal agreed/selected from the license menu, and creating the pass that contains information on the function, the usage period and the like for which usage is to be approved for the software, based on the agreement/selection data; and processing (c) being processing for sending the pass to the user terminal.

Additionally, the user terminal according to the present invention is constructed as comprising: a means for connecting, via the communications line, to the licensing terminal that stores the licensing menu which includes the function, the term and the number of times and the like for which usage may be approved with respect to the software for which the approval of usage is to be given; a means for receiving from the licensing terminal the pass containing information on the function, the term and the number of times and the like which were agreed/selected from the license menu; and a means for sending, to the software, the run-approval or run-disapproval command data according to information on the function, the term and the number of times of use and the like contained in the received pass.

Further, the computer program and the recording medium according to the present invention are constructed as a computer program and computer readable recording medium for storing the program that executes the following processing by means of a control means of the user terminal that can connect via the communications line to the licensing terminal which stores the license menu containing the function, the term and the number of times and the like for which the usage may be approved regarding the software to be usage-approved: processing (a) being processing for creating the agreement/selection data that contains the function, the term and the number of times of use and the like which were agreed/selected from the license menu; and processing (b) being processing for receiving from the licensing terminal the pass which contains the function, the usage period and the like for which usage was approved for the software based on the agreement/selection data and sending, to said software, the run-approval or run-disapproval in accordance with information on the function, the term and the number of times of use and the like contained in the received pass.

Incidentally, the above licensing system of the present invention can be constructed such that the pass given to the user terminal contains a pass status data indicating the current validity of the function, the term and the number of times of use and other such content of usage approval, and then in the case where the pass status data of the pass received from the user terminal is “Valid”, the licensing terminal creates and sends to the user terminal a portable pass which contains information on the functions, the term and the number of times and the like for which use has been approved based on the agreement/selection by that user terminal and the pass status data indicating the current validity of this usage approval content, the portable pass being capable of being moved to another user terminal other than that user terminal; and at said other user terminal it is possible, based on the portable pass which has been moved from the first user terminal, to use the same software as the software that has already been usage-approved at the first user terminal.

Accordingly, the user terminal which can be approved for the usage of the software is not limited to a single terminal, and the same software can be used at another terminal. Therefore, even in the case where a problem has occurred in the user terminal, it is possible to move the software to the other user terminal legally and without worry.

Further, a construction is possible in which, in the above situation, when the user terminal receives the portable pass, it changes the pass status data of the pass to “Currently Being Moved”, sends run-prohibition command data to the software which has already been usage-approved so that the software in question becomes unusable.

Therefore, concurrent usage of the same software at the user terminal and at the other user terminal is prevented; therefore, from the perspective of the software provider, there is the merit that unrestricted copying of the software can be prevented.

Further, in the above licensing system, a construction is possible in which in the case where the pass status data of the portable pass received from the other user terminal is “Currently Being Moved”, the licensing terminal creates a new pass and sends this to the other user terminal; and the other user terminal sends, to the software, run command data in accordance with information on the function, the term and the number of times of use and the like included in the new pass, so that the other user terminal is able to use the software.

Accordingly, the licensing terminal distinguishes the pass status data of the portable pass, to thereby confirm whether or not it should approve of usage of the software by the other user terminal. That is, if the pass status data of the portable pass is “Currently Being Moved”, then the pass that was originally given to the user terminal is valid, meaning that that the license is valid; therefore, the condition for the other user terminal to be able to use the software has been satisfied, and the other user terminal becomes able to use the software. On the other hand, in cases other than “Currently Being Moved”, the condition for the other user terminal to be able to use the software is not satisfied, and the running of the software is appropriately prohibited.

Further, a construction is possible in which, in the above situation, when the other user terminal receives the new pass, it changes the pass status data of the portable pass to “Invalid”, and thus invalidates the portable pass in question.

If the portable pass is invalidated in this way by the other user terminal, it is possible to prevent the portable pass from being reused in order to use the software at yet another user terminal.

The processing performed by the licensing system of the present invention, such as that described above, is controlled and executed by means of software (such as a license management program, a license controller and a license manager which will be described later) which is executed by means of a control means such as central processing units (CPUs) and the like provided to each of the terminals.

The content of the invention is not limited to those in the foregoing description; and the objects, advantages, characteristics and usage thereof are made clearer by the description made hereinbelow with reference to the attached drawings. Further, necessary modifications that are made without departing from the spirit of the invention should be understood as being included within the scope of the invention.

### BRIEF DESCRIPTION OF THE DRAWINGS

In the accompanying drawings:

FIG. 1 is an outline explanatory diagram of a licensing system according to one embodiment of the present invention;

FIG. 2 is an explanatory table showing a data structure of a user account stored in a user account database provided in a license management server machine shown in FIG. 1;

FIG. 3 is an explanatory table showing a data structure of a license base contained in the user account of FIG. 2;

FIG. 4 is an explanatory table showing a data structure of a license validity contained in the user account of FIG. 2;

FIG. 5 is an explanatory table of a data structure of a license menu stored in an application information database provided in the license management server machine of FIG. 1;

FIG. 6 is a flow chart explaining a license menu creation/updating processing procedure, performed on the application information database by a supplier terminal;

FIG. 7 is a flow chart diagram explaining a processing procedure of a license controller, executed by a user terminal shown in FIG. 1;

FIG. 8A is an explanatory table showing a data construction of a fixed passbook, and FIGS. 8B to 8D are explanatory tables showing data structures of a portable passbook;

FIG. 9 is a flow chart diagram showing a processing procedure of a license manager, executed by the user terminal of FIG. 1;

FIG. 10 is a flow chart diagram explaining a processing procedure of a license management program, executed by the licensing terminal of FIG. 1;

FIG. 11 is a flow chart diagram explaining an export processing procedure at the user terminal in a processing for moving, between the user terminal and another user terminal, software for which usage has been approved by the licensing system of FIG. 1;

FIG. 12 is a flow chart diagram explaining an export processing procedure at the license management server machine, in the processing for moving, between the user terminal and another user terminal, the software for which usage has been approved by the licensing system of FIG. 1;

FIG. 13 is a flow chart diagram explaining an export processing procedure at the other user terminal, in the processing for moving, between the user terminal and another user terminal, the software for which usage has been approved by the licensing system of FIG. 1; and

FIG. 14 is a flow chart diagram explaining an export processing procedure at the license management server machine for exporting to the other user terminal, in the processing for moving, between the user terminal and another user terminal, the software for which usage has been approved by the licensing system of FIG. 1.

### DETAILED DESCRIPTION OF THE PREFERRED EMBODIMENTS

Hereinafter, explanation will be made of embodiments of the software licensing system, the licensing terminal, the user terminal and the software recording medium according to the present invention, making reference to the drawings.

1 Outline of the licensing System:

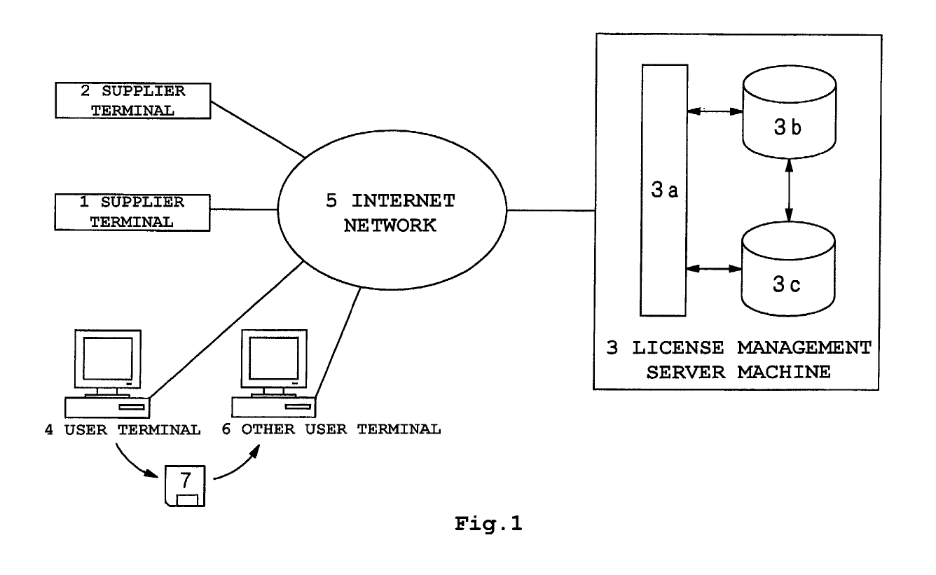

As shown in FIG. 1, the licensing system of the present example is implemented in an environment in which the following are made connectable to each other via an Internet network 6: a plurality of supplier terminals 1 and 2 for providing the software to the user; a license management server machine 3 serving as the “licensing terminal”; and a user terminal 4 which is a personal computer. Therefore, according to the present embodiment, the licensing of the software can be performed in an integrated fashion at the license management server machine 3; and therefore, there is the merit of being convenient for the supplier of the software, and for the user there is the merit of being able to use the licensing system of the present example with software provided from a plurality of suppliers, thus increasing the range of choices.

1.1 Construction of Supplier Terminals 1 and 2:

The supplier terminals 1 and 2 are client machines which are operated under the management of suppliers such as software manufacturers and vendors, and access the license management server machine 3 and perform creation and updating and the like of the license menu stored therein. This creation, updating and the like are performed by means of a license menu manager 1a, which is executed by CPUs (not shown) which serve as the control means of the supplier terminals 1 and 2. Note that, the supplier terminals 1 and 2 may also be provided with ftp servers for downloading the software to the user terminal 4.

1.2 Construction of the License Management Server Machine 3:

The license management server machine 3 is the core of the licensing system of the present example; as such, a license management program 3a, which is executed by the CPUs that serve as the control means (not shown), accesses a provided user account database 3b and application information database 3c, and carries out communications controls with the supplier terminals 1 and 2 and the user terminal 4.

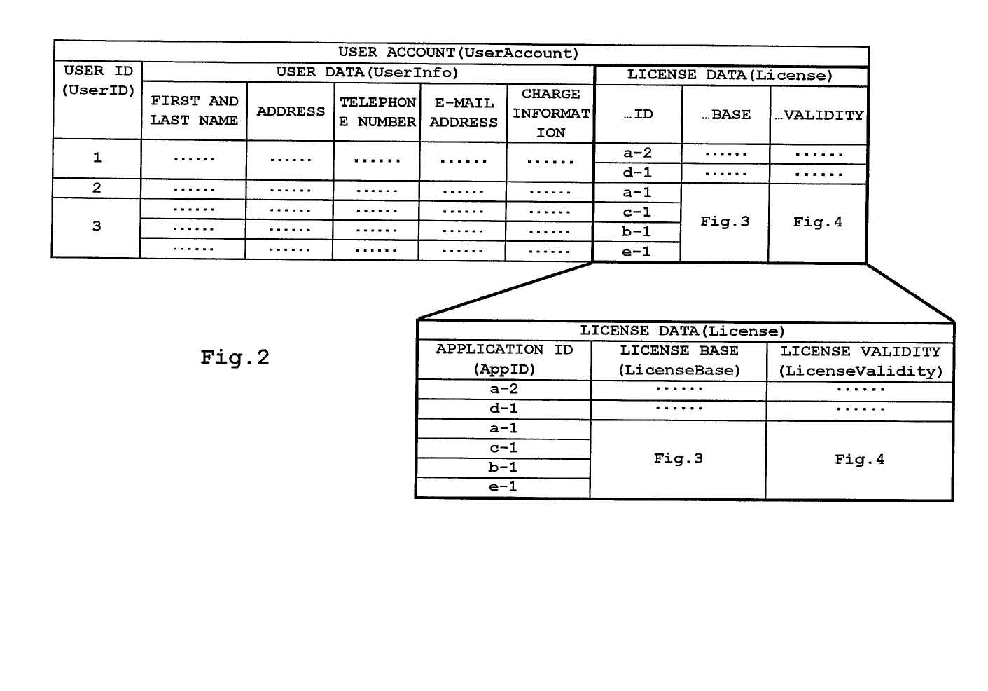

In the user account database 3b, there is stored a “user account” such as shown in FIG. 2; and writing thereto, reading therefrom and the like are managed by the above-mentioned license management program 3a. In the user account, there is registered a “user ID (UserID)” for each user, and in each user ID there are stored “user data (UserInfo)” and “license data (License)”. The user data is information which the user himself inputs upon user registration, in which there is stored data such as “first and last name”, “address”, “telephone number”, “email address” and credit card number or other such “charging information”. As the license data, there is given an “application ID (AppID)” for specifying the software (i.e., including such content as the software in its entirety, a partial functional program of the software, image data that can be used with the software, musical data or the like) which is approved for use with respect to each user, and for each application ID there are stored a “license base (LicenseBase)” and a “license validity (LicenseValidity)”.

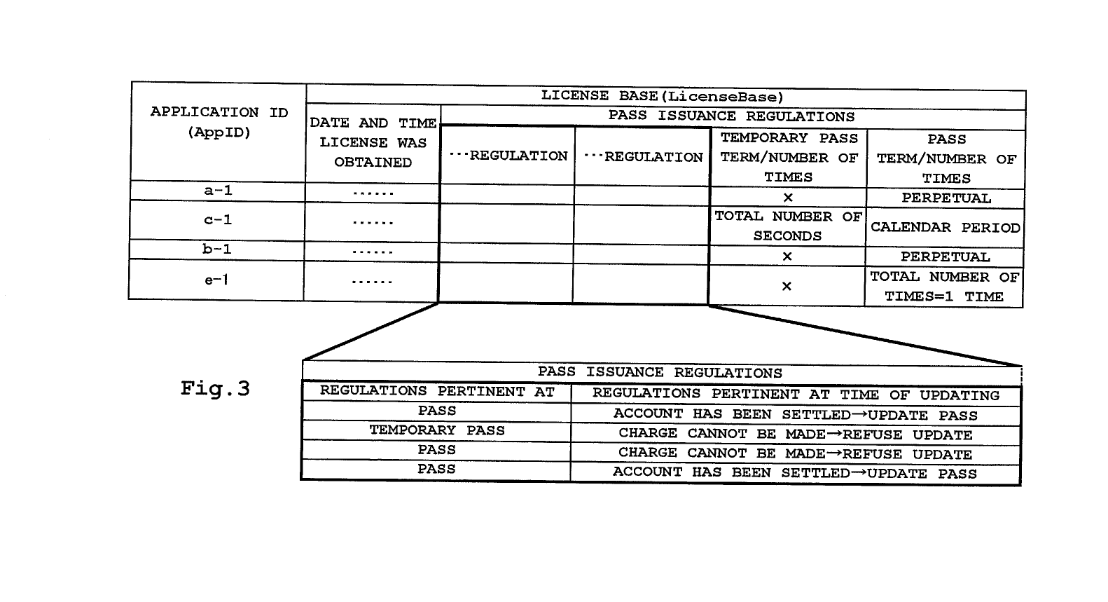

In the license base, there is included data pertaining to license conditions of software corresponding to the application ID. Namely, as shown in FIG. 3, there are included a “date and time when license was obtained”, “pass issuance regulations (i.e., regulations regarding conditions of issuance applied at the time of purchase or at the time of updating the pass)”, a “temporary pass term and number of times of use (i.e., time element of the license (ex, ‘perpetual’ indicating usability without a time restriction, ‘calendar period’ indicating that usage is allowed during a specified period on a calendar, ‘total number of times of use’ indicating that usage is allowed up to a specified total number of times) and a “pass term and number of times of use” having content similar to that of the “temporary pass term and number of times of use”. Note that, the “x” in the temporary pass term and number of times of use in FIG. 3 is a symbol meaning an unused item, indicating an entry space left empty in the case where it is not necessary to enter the data.

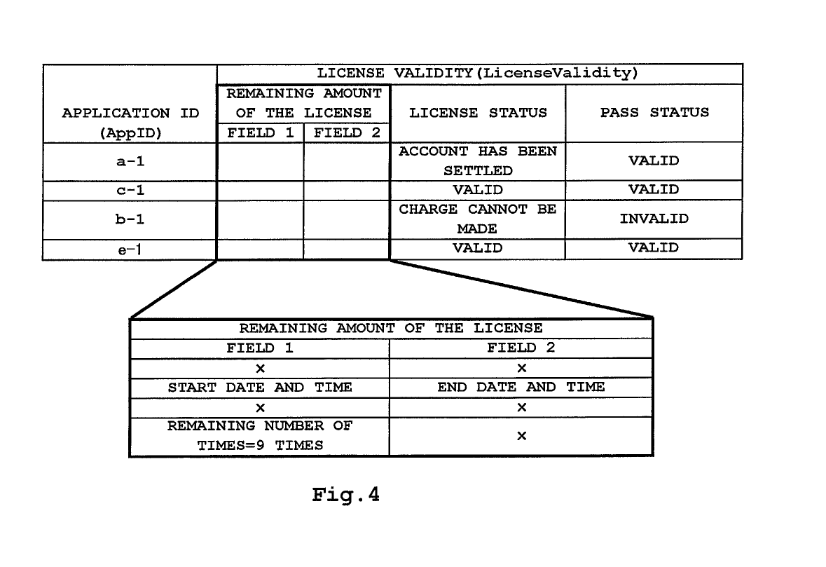

Further, in the license validity, there is included data pertaining to the current license status regarding each application ID. Namely, this is respective data of a “remaining amount of the license”, the “license status” and the “pass status”, which are shown in FIG. 4. Among these, data to be written in the “remaining amount of the license” is comprised of the following: the “x” in the case where the usage-approval for the application ID is “perpetual”; a start date and time, and an end date and time in the case when the usage-approval is for the “calendar” period; a total remaining duration of time in the case when the usage-approval is for the “total duration of time of use”; and a remaining number of times of use in the case where the usage-approval is for the “total number of times of use”. Further, the license status is composed of data indicating whether the license is valid or not, in accordance with actual performance of a payment for the charge applied.

As stated above, the license management server machine 3 is configured such that the license management program 3a accesses the user account database 3b, whereby it can immediately detect, with respect to each user (i.e., for each user ID), the following: the application (i.e., application ID) for which license is granted; the conditions of the license contract (i.e., license base); and the current status of that license (i.e., license validity).

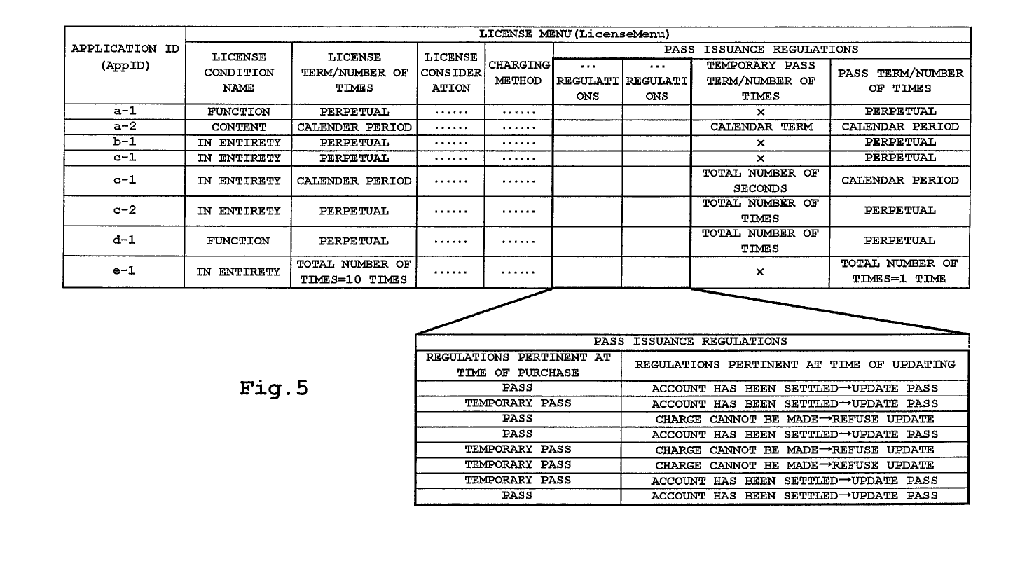

In the application information database 3c, there is stored information pertaining to the license conditions for the software of which usage is approved, such as is shown in FIG. 5. Specifically, for each “application ID (AppID)” there is registered the “license menu (LicenseMenu)”. The registration is performed by the supplier terminals 1, 2 accessing the license management server machine 3 via the internet network, as described above. Note that here, even when registration is made for the same software (for example, in the case of registering “a-1” and “a-2” which both contain “a” in the software ID), it is possible to register a plurality of license menus therefor, according to the content of the usage approval (i.e., a function program in “a-1”, and contents such as image data in “a-2”). Further, even in the case when the content of the usage approval is the same for the same software (for example, “c-1” and “c-1”), it is possible to register a plurality of license menus according to the time elements of the usage-approval (“perpetual” in the top “c-1” and the calendar period in the bottom “c-1”). This configuration is adopted in order to provide a variety of licensing menus to meet various needs of users—including a user who basically wants usage-approval for the entire software, a user who only wants usage-approval for a partial functional program of the software, a user who wants usage-approval for only a predetermined period of time, for example—even for the same single software. A“license condition name” included in the license menu of FIG. 5 is a name for distinguishing the license conditions (content) for the software is to be usage-approved. A “license term/number of times of use” is data indicating the time element of the license, in which the software provider sets “perpetual”, “calendar period” “total duration of time of use” or “total number of times of use” for each application ID. A “license fee” is a monetary amount, and a “charging method”, which is a method of payment thereof, is also selected and set by the software supplier. Further, in the “pass issuance regulations”, “regulations pertinent at time of purchase” -stipulates a type of pass which is to be issued, and “regulations pertinent at time of renewing” stipulates how the renewing of the pass should be processed according to the charging status. The “temporary pass term and number of times of use” and the “pass term and number of times of use” stipulate how to adjust the remaining amount of the license validity at the time of renewal of the license validity and at the time of renewal of the pass.

1.3 Construction of the User Terminal 4:

The user terminal 4 of FIG. 1 is a personal computer. The user terminal 4 is provided with a license execution program composed of two modules: a license controller 4a necessary for implementing the licensing system of the present example, and a license manager 4b. The license execution program is executed by the CPU which is the control means and is not shown in the diagram. The license controller 4a is a program functioning as an interface or the like to the software for which usage approval is to be given and is used at the user terminal 4. The license controller 4a creates and sends to the software the run-approval or run-disapproval command data in accordance with information on the function, the term and the number of times of usage and the like contained in the pass discussed later, and the operations of the software are controlled according thereto. The license manager 4b is a program function as an interface to the user and the license management server machine 3. The license manager 4b controls such operations as the receiving of the pass created and sent by the license management server machine 3, and the displaying of the license menu, which is sent from the license management server machine 3, to the user via a display or other such output device M.

2 Explanation of Various Processing By the Licensing System:

Explanation will now be made of various processing performed by the licensing server generally constructed as described above.

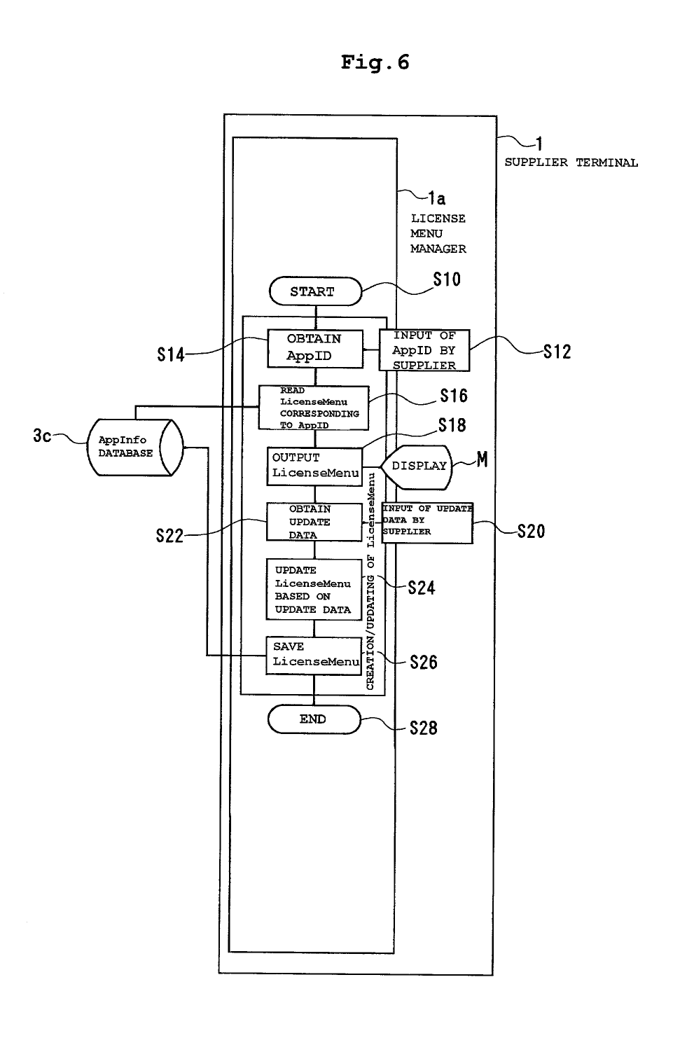

2.1 Registration into License Menu of Software for Which Usage-approval is to be Given (FIG. 6):

In order to implement the licensing system according to the present embodiment, it is first necessary for the software supplier to create and register a license menu for the software that is the subject of the usage-approval. The processing for this is performed by means of the license menu manager 1a executed from the supplier terminals 1, 2. That is, as shown in FIG. 6, when the license menu manager 1a is booted at the supplier terminal 1 (s10) and the supplier then inputs the application ID (s12), the license menu manager 1a then accesses the application information database 3c of the license management server machine 3 based on the application ID it has obtained (s14), and then reads the license menu that corresponds to that application ID (s16). However, at the time when a new registration is being made, the license menu has not been registered yet; therefore, the license menu is not displayed at the supplier terminal 1 (s18), and instead, data input is performed for each of the license menu items shown in FIG. 5 (s20). When the data has been obtained (s22), the license menu manager 1a updates the license menu (s24) and saves it in the application information database 3c (s26). Thus, the new registration in the license menu is completed (s28); however, the registered content can be updated by following the same procedure as described above.

2.2 Processing for Approval of Usage of the Software for Which Usage-approval is to be Given:

Next, explanation will be made of a processing procedure by which the user receives the usage-approval, based on the licensing system of the present example. Note that the explanation is made on the basis of the following assumption that, although software containing a function program for which the usage-approval is to be received has already been installed into the user terminal 4 from a CD-ROM or other such recording medium by the user as preparation to receive the usage-approval, but that use of the software is currently disabled. Further, it is assumed here that the application ID of the function program of the software for which the usage-approval is to be given is “a-1”.

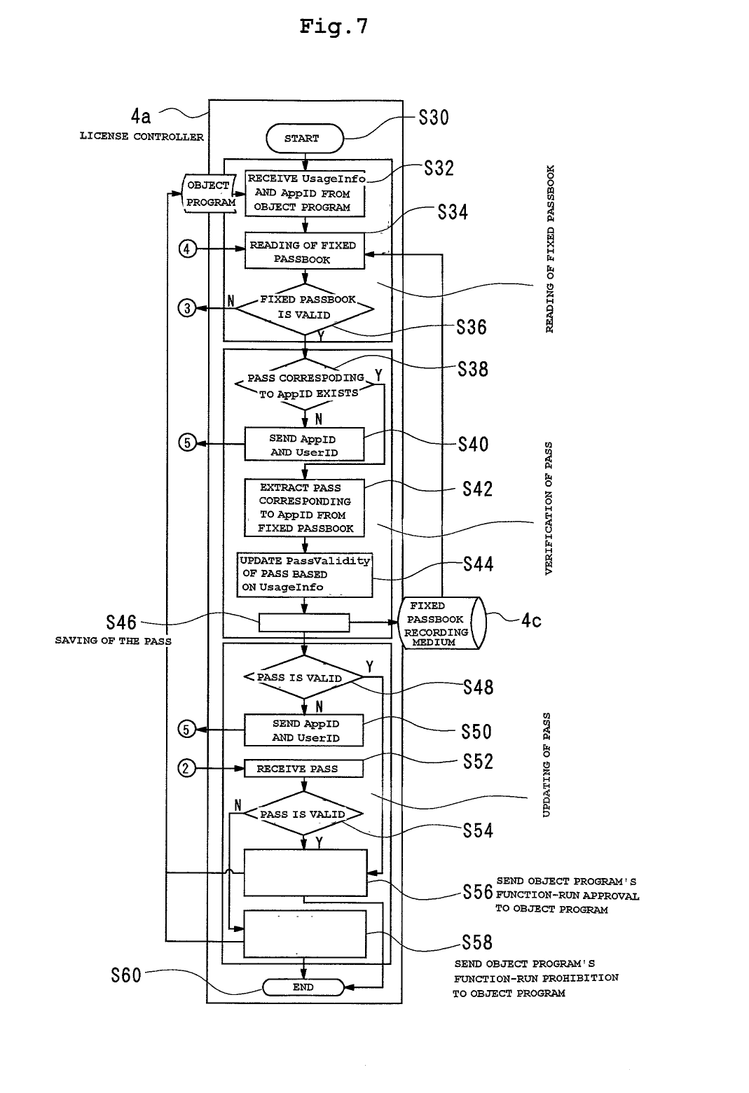

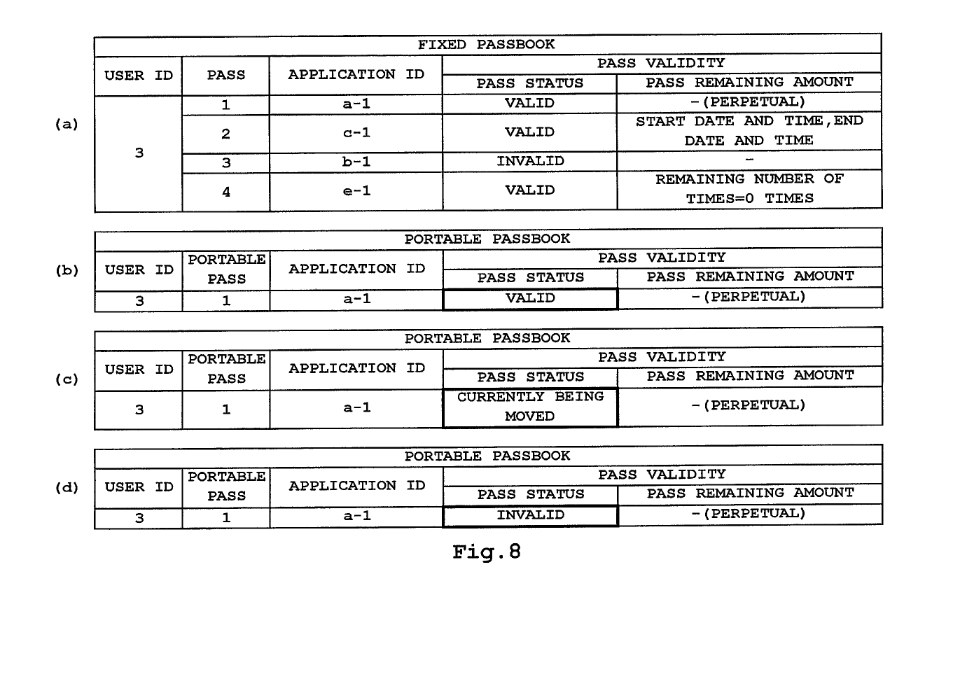

(1) Reading of the Fixed Passbook (FIG. 7 and FIG. 8A):

First, when the user terminal 4 boots the license management program which is composed of the license controller 4a and the license manager 4b (s30), the license controller 4a obtains the application ID “a-1” and the usage data (UsageInfo) from the software which is installed in the user terminal 4. The usage data is data which indicates a term/number of times that the user terminal has actually used the content for which usage was approved, based on the present licensing system. The content of the usage data is indicated as follows, according to the term/number of times of use of the pass or the temporary pass shown in FIG. 5: namely, in the case where the term/number of times of use of the pass or the temporary pass is “perpetual”, then the content is indicated as being unused; in the case of “calendar period”, the content is indicated as the calendar period which has already been used; in the case of “total duration of time of use”, it is indicated as the total duration of time which has already been used; and in the case of “total number of times of usage”, it is indicated as the total number of times that the software has already been used. However, here the usage-approval has not yet been received from the licensing system of the present example; therefore, the usage data corresponding to the application ID “a-1” cannot be obtained, so only the application ID “a-1” is obtained from the software installed in the user terminal 4a (s32).

Then, the license controller 4a reads the fixed passbook that corresponds to the obtained application ID “a-1” from a fixed passbook recording medium 4c (s34). Here, the fixed passbook is for collectively managing in the user terminal 4 the passes that contain the function, the term and the like for which usage has been approved for software that is subject to usage-approval (see FIG. 8(a)). Further, the fixed passbook recording medium 4c is a medium for recording the fixed passbook, and in the present example, a hard disk provided to the user terminal 4 is used as the fixed passbook recording medium 4c; however, it is also possible to use another recording medium. Further, the license controller 4a judges the validity of the fixed passbook which has been read out (s36). The fixed passbook is judged to be “valid” only in the case where the fixed passbook exists in the fixed passbook recording medium 4 and the user ID is contained in the fixed passbook. Here, however, since the fixed passbook has not been recorded into the fixed passbook recording medium 4c and thus cannot be read out, the fixed passbook is judged to be “invalid”. In this case, the processing transfers over to the license manager 4b next.

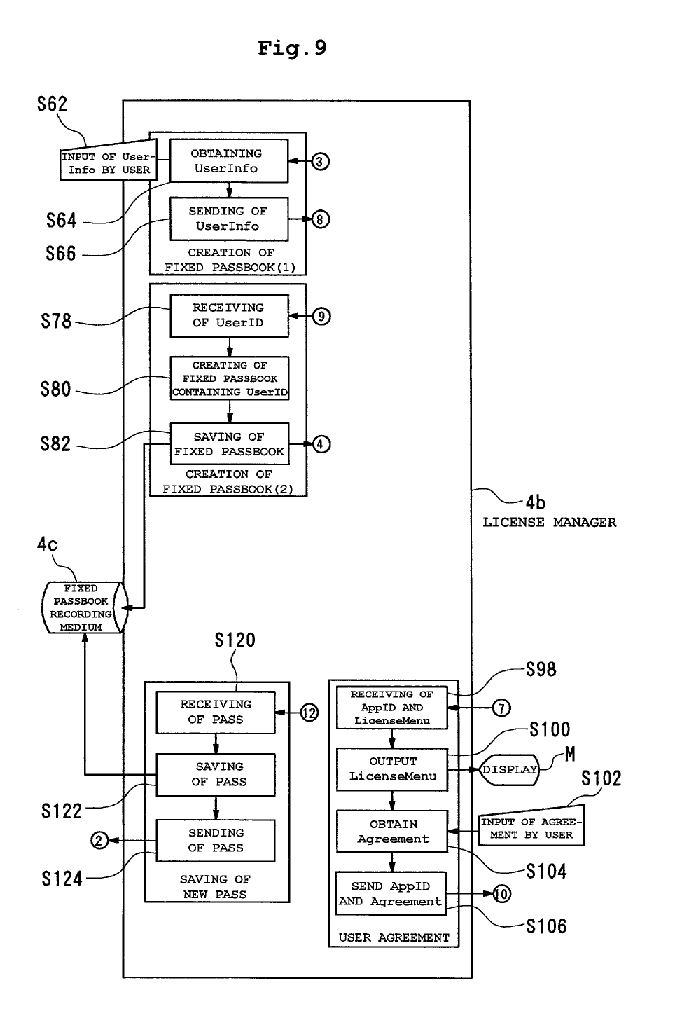

(2) Fixed Passbook Creation (i) (FIG. 9):

First, when the user operates the input device and completes the input of the user data in the user account shown in FIG. 2 (s62), the license manager 4b in the user terminal 4 sends the user data to the license management server machine 3 via the Internet network 5 (s64, s66).

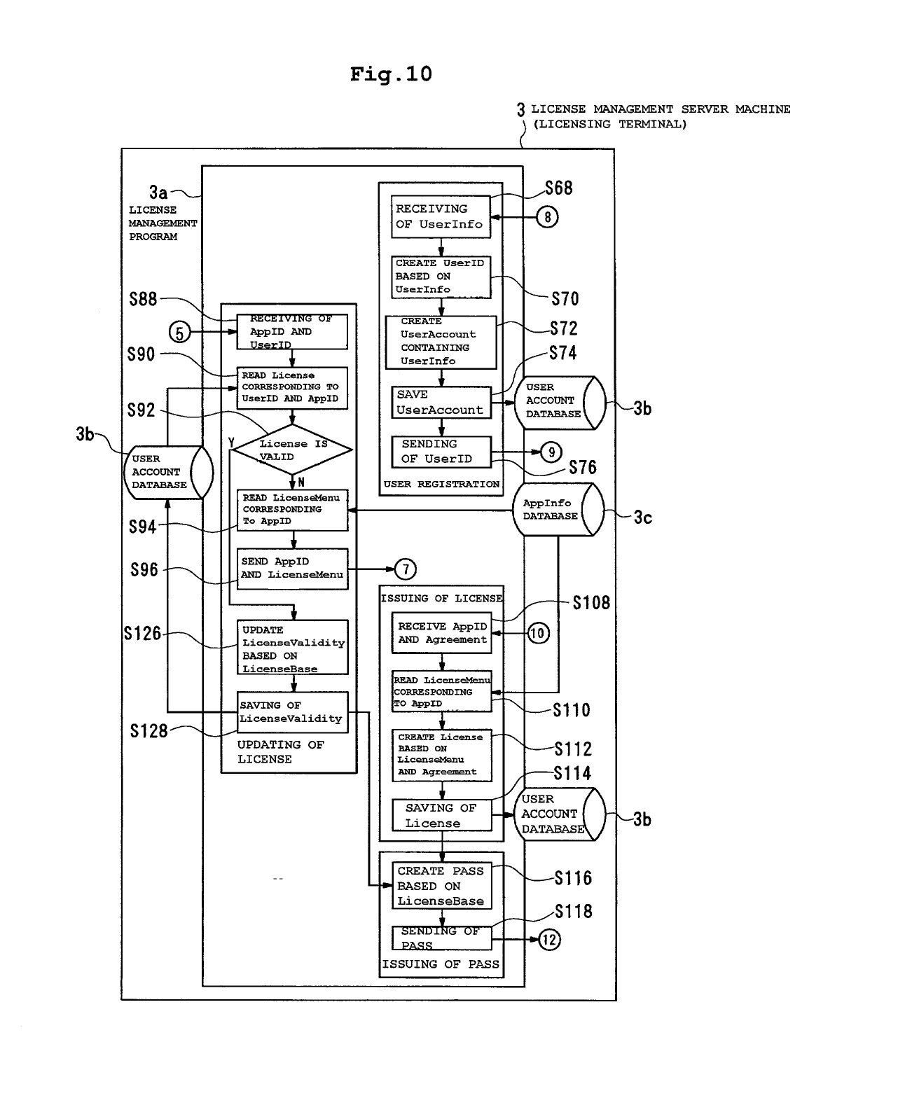

(3) User Registration (FIG. 10):

When this happens, the license management program 3a of the license management server machine 3 creates the user ID based on the received user data (s70) and also creates the user account containing the user ID and the user data (s72). Note that, it is assumed here that the user ID thus created is a user ID “3” shown in FIG. 2. Then, the user account that has been created is saved into the user account database 3b (s74), and also, the user ID “3” is sent to the user terminal 4 (s76).

(4) Fixed Passbook Creation (ii) (FIG. 9):

After the license manager 4b in the user terminal 4 receives the user ID “3” (s78), it then creates the fixed passbook containing this ID (see FIG. 8A; s80) and saves the fixed passbook into the fixed passbook recording medium 4c (s82). When the fixed passbook for this user ID “3” has thus been created, the processing then transfers over to the license controller 4a again.

(5) Reading of the Fixed Passbook (FIG. 7):

The license controller 4a reads the fixed passbook from the fixed passbook recording medium 4c in the same way as described above (s34) and judges the validity thereof (s36). This time, the fixed passbook exists in the fixed passbook recording medium 4c and the user ID “3” exists in the fixed passbook; therefore, the fixed passbook is judged to be “valid”.

(6) Updating the Pass (FIG. 7):

Next, the license controller 4a judges whether the pass corresponding to the application ID “a-1” exists in that fixed passbook or not (s38). Since it is being assumed here that the new usage-approval has not yet been received with respect to the function, the term, the number of times of usage and the like for the software, the pass does not exist. Therefore, the license controller 4a sends the application ID “a-1” and the user ID “3” to the license management program 3a of the license management server machine 3 (s40).

(7) Updating the License Data (FIG. 10):

The license management program 3a reads out, from the user account database 3b, the license data that corresponds to the received application ID “a-1” and the user ID “3” (s88, s90), and judges whether the license data is valid or not (s92). In this validity judgment, the judgment of “Valid” is made only in the case where the license data exists in the user account and the license validity in the license data has a value indicating validity (i.e., which is the case where the “remaining amount of the license”, shown in FIG. 4, still indicate some amount remaining, and the license condition has a value “valid”). However, explanation is being made, here, of the situation in which the usage-approval is received for the first time; therefore, it is assumed that the license data does ;not exist in the user account shown in FIG. 2. Therefore, the license management program 3a judges that the license data is “Invalid”, reads out the license menu that corresponds to the application ID “a-1” from the application information database 3c (s94), and sends the application ID “a-1” and the license menu therefor to the user terminal 4 (s96).

(8) User Agreement (FIG. 9):

The license manager 4b in the user terminal 4 receives the application ID “a-1” and the license menu (s98), and outputs the license menu to the output device M of the user terminal 4 (s100). What is displayed at this time is the license menu that corresponds to the application ID “a-1” shown in FIG. 5. The user sees this license menu and can select it in the case where he or she agrees to the content thereof (s102). The license manager 4b obtains the agreement/selection data (Agreement) which has been generated based on the user's agreement/selection, and sends the application ID “a-1” and the agreement/selection data to the license management server machine 3 (s106). Note that, in the agreement/selection data, there are included the license condition name, the license term and number of times of use, the pass issuance regulations, the temporary pass term and number of times of use, the pass term and number of times of use and such of the license menu shown in FIG. 5.

(9) Issuance of the License Data (FIG. 10):

The license management program 3a reads out the license menu corresponding to the received application ID “a-1” from the application information database 3c (s108, s110), and creates license data such as indicated by the application ID “a-1” of the user ID “3” and FIGS. 2 to 4 (s112), and saves this license data into the user account database 3b (s114).

(10) Issuing of the Pass (FIG. 10):

Next, the license management program 3a issues the pass based on the license data which has just been created/saved. This pass is created based on the license data (s116); however, in the license base of the license data, there are included the pass issuance regulations. According to the “regulations pertinent at time of purchase” corresponding to the application ID “a-1”, a “pass”—not a “temporary pass”—is to be issued at the time of purchase. And in accordance with the “pass term and number of times”, the validity of the pass is to be “perpetual”, in which updating of the pass is unnecessary (FIG. 2, FIG. 3). Therefore, according to the present example, the “pass” having the time element “perpetual” is to be issued and sent to the user terminal 4 (s118). The pass which is created here is pass “1” in FIG. 8(a), and the application ID “a-1” and the pass validity are included therein. By sending of this pass “1”, the new usage-approval for the user is given to the user terminal 4 for the function program that corresponds to the application ID “a-1”.

(11) Saving the New Pass (FIG. 9):

At the user terminal 4, the license manager 4b receives the pass “1” (s120), and saves it in the hard disk fixed passbook recording medium 4c. As this happens, the pass “1” is sent to the license controller 4a.

(12) Verification of the Pass (FIG. 7):

The license controller 4a judges whether the received pass “1” is valid or not (s52, s54). In this validity judgment, the judgment of “Valid” is made only in the case where the pass status of the pass “1” of FIG. 8(a) indicates “Valid”, and the remaining amount of the pass still has some amount remaining. It is being assumed, here, that the pass status of the pass “1” is “Valid”, and that the remaining amount of the pass is “−(perpetual)”, so the pass “1” is valid. Therefore, the license controller 4a creates command data to approve the running of the application ID “a-1” contained in the pass “1”, and sends this to the software installed in the user terminal 4 (s56). Accordingly, the user terminal 4 can now use the function program of the application ID “a-1”, which could not be used previously for the software.

Thus, the processing procedure for the approval of the usage of the application ID “a-1” by the user terminal 4 is completed (s60). Note that, approval of usage for passes “2”, “3” and “4” of the user ID “3”, which are included in the fixed passbook of FIG. 8(a), can also be performed according to the same procedure as described above; however, when the user registration, the creation of the fixed passbook and the like have already been taken care of, this processing is thus eliminated. Correspondingly, the usage-approval processing becomes more simplified, and the usage-approval can be received sooner.

2.3 Processing of Updating the Usage-approval for the Software That Has Been Usage-approved (i):

For software that has been usage-approved by means of the above procedure, it is assumed that there will also be cases involving a term limitation or a limitation on the number of times (of usage), such as in the case of application IDs “c-1” and “e-1” in the license menu of FIG. 5, for example. Explanation will now be made of processing of updating the software (i.e., processing of updating the pass) which has already been approved for usage once, in such a situation.

As one example of this updating processing, explanation will be made of the case where the usage-approval has been received for the application ID “e-1” in the license menu shown in FIG. 5 based on the licensing system of the present example. Here, the license menu of FIG. 5 shows that the license term and number of times for the application ID “e-1” is “total number of times=10 times”. Further, the pass term and number of times is “total number of times=1 time”. Therefore, each time the software of the application ID “e-1” is used once by the user terminal 4, the “remaining pass amount” in the “pass validity” shown in FIG. 8(a) is completely lost. Accordingly, the user must update the pass “4” each time that the software is used once. The following explanation will be made on the assumption that the software corresponding to the application ID “e-1” has already been used once.

(1) Reading the Fixed Passbook (FIG. 7):

First, when the user terminal 4 uses the software “e-1” for which the usage-approval has been given, the license controller 4a obtains the user data and the application ID “e-1” from the software “e-1” (s32), and then reads the fixed passbook from the fixed passbook recording medium 4c (s34) and judges the validity thereof (s36). Here, as shown in FIG. 8(a), the fixed passbook does exist and the user ID is included in the fixed passbook; therefore, the fixed passbook is judged to be “Valid”.

(2) Updating the Pass (FIG. 7):

Next, the license controller 4a judges whether the pass for the application ID “e-1” exists or not (s38). Here, as shown in FIG. 8(a), the pass “4” for the application ID “e-1” does exist in the fixed passbook. Therefore, the license controller 4a extracts the pass “4” from the fixed passbook (s42). Then, at step 32, the “pass validity” of the pass “4” is updated based on the usage data of the already-obtained software corresponding to the application ID “e-1” (s44). This updating processing is performed by decreasing the value of the “remaining amount of the pass” in the “pass validity” shown in FIG. 8(a) by an amount of a value of past usage, which is indicated in the usage data. According to the present example, the software corresponding to the application ID “e-1” has been used once; therefore, when this processing is performed, the value of the “remaining amount of the pass” is updated to a value of “zero” (s44). Here, the pass “4”, which contains the “remaining amount of the pass” that has been updated to the value of “zero”, is saved once in the fixed passbook recording medium 4c (s46).

(3) Verification of the Pass (FIG. 7):

Next, the license controller 4a judges the validity of the pass “4” (s48). In this validity judgment, a judgment of “Valid” is made only in the case where the “remaining amount of the pass” in the “validity” shown in FIG. 8(a) has a value that is greater than zero and the “pass status” indicates “valid”. Here, the “pass condition” is “valid”, but, as mentioned above, the “remaining amount of the pass” has been updated to the value of “zero”; therefore, the pass “4” is judged to be not valid. Thus, the license controller 4a sends the application ID “e-1” and the user ID “3” to the license management server machine 3 (s50).

(4) Updating of the License Data (FIG. 10):

The license management program 3a in the license management server machine 3 reads out, from the user account database 3b, the license data that corresponds to the received user ID “3” and to the application ID “e-1” (s88, s90), and judges the validity of this license data (s92). In this validity judgement, a judgment of “Valid” is made only in the case where the license data exists and the “remaining amount of the license” in the license validity in FIG. 4 has a value that is greater than zero such that the “license status” is “Valid”. Here, the software corresponding to the application ID “e-1” was only used once by the user terminal 4, and the “remaining amount of the license” is “remaining number of times=9 times”, not “zero”. Also, the “license status” is “Valid”. Therefore, the license management program 3a advances to step 126 and the license validity is updated according to the license base. This updating is performed by replacing the “remaining amount of the license”, which indicates the license validity, with a value which is derived by subtracting the “total number of times=1 time” shown in the “pass term/number of times” in the “pass issuance regulations” of the license database from the “remaining number of times=9 times” shown in the “remaining amount of the license” which indicates the license validity (see FIG. 4) (namely, “8 times”). When this updating is completed, the license management program 3a saves the updated license validity in the user account database 3b (s128) and issues the pass.

(5) Issuing of the Pass (FIG. 10):

The issuing of the pass is performed based on the license base of the license data that was read out from the user account database 3b at step 90. That is, the license management program 3a performs the processing of replacing the “remaining amount of the pass” of the “pass validity” corresponding to the application ID “e-1” with the “total number of times=1 time” shown in the “pass term/number of times (of usage)” included in the “pass issuance regulations” of the license base, creates the pass (FIG. 8(a), s116), and sends the pass to the user terminal 4 (s118).

(6) Subsequent Updating Processing:

Then, subsequent updating processing is performed going through the same processing procedure as has already been explained. That is, if the saving of the new pass by the user terminal 4 (s120-s124) and the verification of the pass (s52-256) are executed in order, then the usage-approval for the software corresponding to the application ID “e-1” can be updated.

2.4 Processing of Updating the Usage-approval for the Software That is the Subject of the Usage-approval (ii):

According to the above, the usage-approval for the software corresponding to the application ID “e-1” can be updated repeatedly; however, since the “license term/number of times” in the license menu of FIG. 5 is set as “total number of times=10 times”, the total number of times for the updating is limited to 10. What will be explained next are a processing procedure for a case where the license is continually purchased and for a case where the license not continually purchased, when the “remaining amount of the license” indicating the license validity of the user account in FIG. 2 has become “remaining number of times=0 times”.

(1) The Case Where the Continued Purchase is Made:

Even if the usage of the software corresponding to the application ID “e-1” reaches its 10th time (s30), when the fixed passbook is read (s32-s36), the updating of the pass (s38, 42, 44, 46) and the verification of the pass (s48, s50) are still performed (FIG. 7). Then, after that, the updating of the license data is performed by the license management server machine 3 (s88, s90 (FIG. 10)); however, the “remaining amount of the license” of the license validity in the user account in FIG. 2 has already become “remaining amount of times=0 times”, so the license data is judged to be “Invalid” at step S92. When this occurs, the license management program 3a reads the license menu corresponding to the application ID “e-1” from the application information database 3c (s94) and sends the license menu to the user terminal 4 (s96). At the user terminal 4, the user agreement is performed (s98-s106 (FIG. 9)). In this agreement process, in the case where the user is to make a continued purchase of the same application ID “e-1”, it is sufficient if the user agrees to/selects the same application ID “e-1” again. After that, the issuing of the license data (s108-s114 (FIG. 10)), the issuing of the pass (s116, s118 (FIG. 10)), the saving of the new pass (s120-s124 (FIG. 9)) and the verification of the pass (s52, s54, s56, s60 (FIG. 7)) are carried out in the same way as described above, producing the result that the software corresponding to the application ID “e-1” can be used.

(2) The Case Where the Continued Purchase is not Made:

In contrast to the case where the continued purchase is made, what is different between the two cases is the user agreement at steps 98-106 in FIG. 9. That is, in the case where the continued purchase is not to be made, agreement/selection data indicating that the purchase is not to be made is sent by the user terminal 4 to the license management server machine 3 at step 106. When this occurs, at step 112 in the license data issuing process (FIG. 10), the license management program 3a creates a license data in which the “pass status” of the license validity is “Invalid”. Then, at the subsequent step 116, a pass is created having the pass validity “pass status” that is “Invalid”, and this pass is sent to the user terminal and saved (s118, s120, s122, s124). The saved pass is sent to the license controller 4a (step 52) and the validity of this pass is judged at step 54 (FIG. 7); however, the “pass status” of the pass validity of the pass is “Invalid” here, so a run-prohibition command data is sent out to the software that corresponds to the application ID “e-1” (s58). A result is thus produced such that the software cannot be used by the user terminal 4.

3 Explanation of Moving of Usage-approved Software Between Terminals By the Licensing System of the Present Example:

In the case where the software licensing system of the present example, as executed as discussed above, gives approval to the user terminal 4 for the usage of the software, the use of the software by the user terminal 4 can be prohibited and the software can then be sent to another user terminal 6. This moving is executed by export processing performed between the user terminal 4 and the license management server machine 3, and import processing performed between the other user terminal 6 and the license management server machine 3. Note that, here, explanation will be made of an example in which the movement is attempted for passes “1” and “3” of the fixed passbook shown in FIG. 8(a).

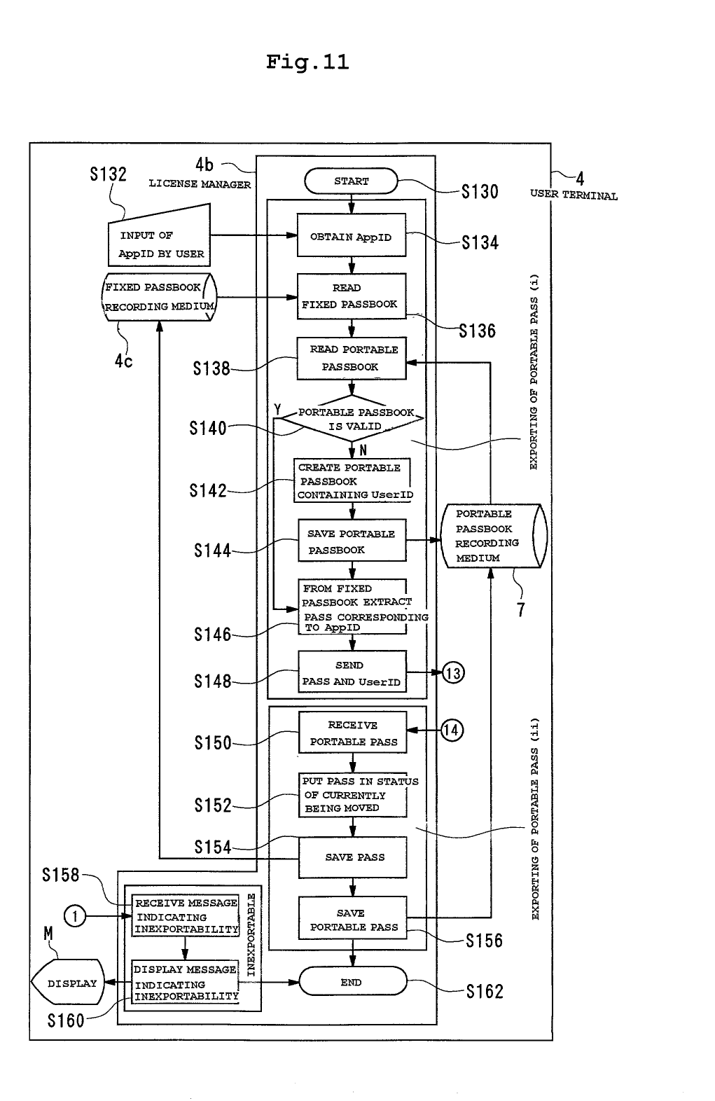

3.1 Exporting of the Portable Pass (i) (FIG. 11):

First, the user boots the license manager 4b in the user terminal 4, and then inputs application IDs “a-1” and “b-1” (s132). After the license manager 4b has obtained these applications IDs, it then reads out the fixed passbook from the fixed passbook recording medium 4c (s136), reads out the portable passbook from a portable passbook recording medium 7 (s138), and judges the validity of the portable passbook (s140). In this validity judgment, a judgment of “Valid” is made only in the case where the portable passbook exists in the portable passbook recording medium 7 and the user ID is contained in the portable passbook.

Note that, the portable passbook recording medium 7 is a recording medium for moving the portable passbook between the user terminal 4 and the user terminal 6, and in the case where the two terminals 4 and 6 are connected to each other in a peer-to-peer configuration, or by a LAN, or are otherwise similarly capable of mutual sending and receiving of data via a cable, it then also becomes possible to use the hard disk of the user terminal 4 as the portable passbook recording medium 7. Further, in the case where the two terminals 4 and 6 are not connected to each other, as in FIG. 1, it is possible to use a flexible disk, a CD-RW, or another such portable recording medium as the portable passbook recording medium 7. Note that, the portable passbook recording medium 7 of the present example is a flexible disk.

In the above-mentioned step 140, the portable passbook does not exist in the user terminal 4; therefore, the license manager 4b creates a portable passbook containing the user ID “3” (s142), and stores this in the flexible disk portable passbook recording medium 7 (s144). Then, the passes “1” and “3” corresponding to the application IDs “a-1” and “b-1” and the user ID “3” are sent to the license management server machine 3.

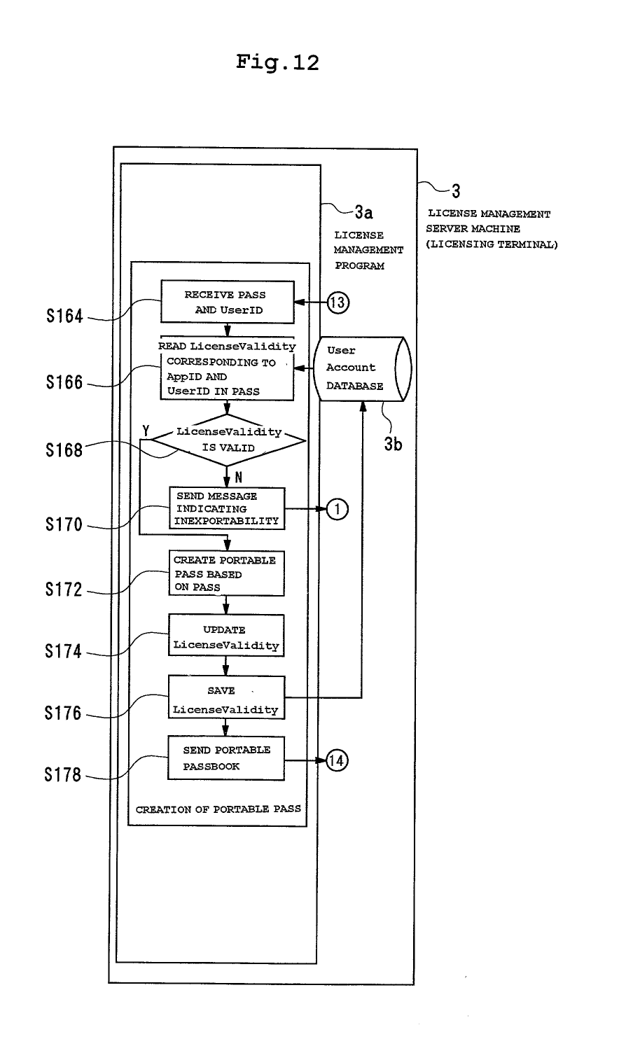

3.2 Creation of the Portable Pass (FIG. 12):

After the license management program 3a receives the passes “1” and “3” and the user ID “3” (s164), the license management server machine 3 reads, from the user account database 3b, the license validity corresponding to the application IDs “a-1” and “b-1” in the passes “1” and “3” and corresponding to the user ID “3” (s166), and judges the license validity (s168). In this validity judgment, a judgment of “Valid” is made only when the following three conditions are met: the “remaining amount of the license” of the license validity has a value greater than zero, the “license status” has a “Valid” value, and the “pass status” has a “Valid” value. Here, as shown in FIG. 4, for the application ID “a-1”, the “remaining amount of the license” is still unused and is “perpetual”, and the “license status” and the “pass status” are both “Valid”; therefore the judgement of “Valid” is made. On the other hand, for the application ID “b-1”, the “remaining amount of the license” indicates unused and “perpetual”, but the “license status” indicates “charge cannot be made” and the “pass status” is “Invalid”; therefore, a judgement of “Invalid” is made, and a message indicating inexportability is sent to the user terminal 4 by way of step 170 (s170), and this message is displayed on an output device M such as the display of the user terminal (s160).

Therefore, since the license validity is “Valid” only for the application ID “a-1”, the license management program 3a creates a portable pass “1” based on the received pass “1” (s172). This portable pass “1” is created by duplicating both the “pass status” and the “remaining amount of the pass” which are each in the pass validity of the pass “1”, and combining them with the application ID “a-1”, as shown in FIG. 8(b). Then, the license management program 3a replaces the “pass status” of the license validity with “Currently Being Moved”, updates the license validity (s176) and sends the created portable pass “1” to the user terminal 4 (s178), as shown in FIG. 8(c).

3.3 Exporting of the Portable Pass (ii) (FIG. 11):

When the user terminal 4 receives the portable pass “1” (s150), the “pass status” in the pass validity of the pass “1” is replaced with “Currently Being Moved”, to thereby put the pass “1” into the status of currently being moved (s152), and then, the pass “1” is saved into the fixed passbook recording medium 4c (s154). By thus making the “pass status” become “Currently Being Moved”, the run-prohibit command data for the software corresponding to the application ID “a-1” is sent to the user terminal 4 based on the pass “1”, and the software in question becomes unusable for the time being. At the same time, the portable pass “1” is saved into the portable passbook recording medium 7. Thus, the exporting processing of the portable pass “1” is completed (s162).

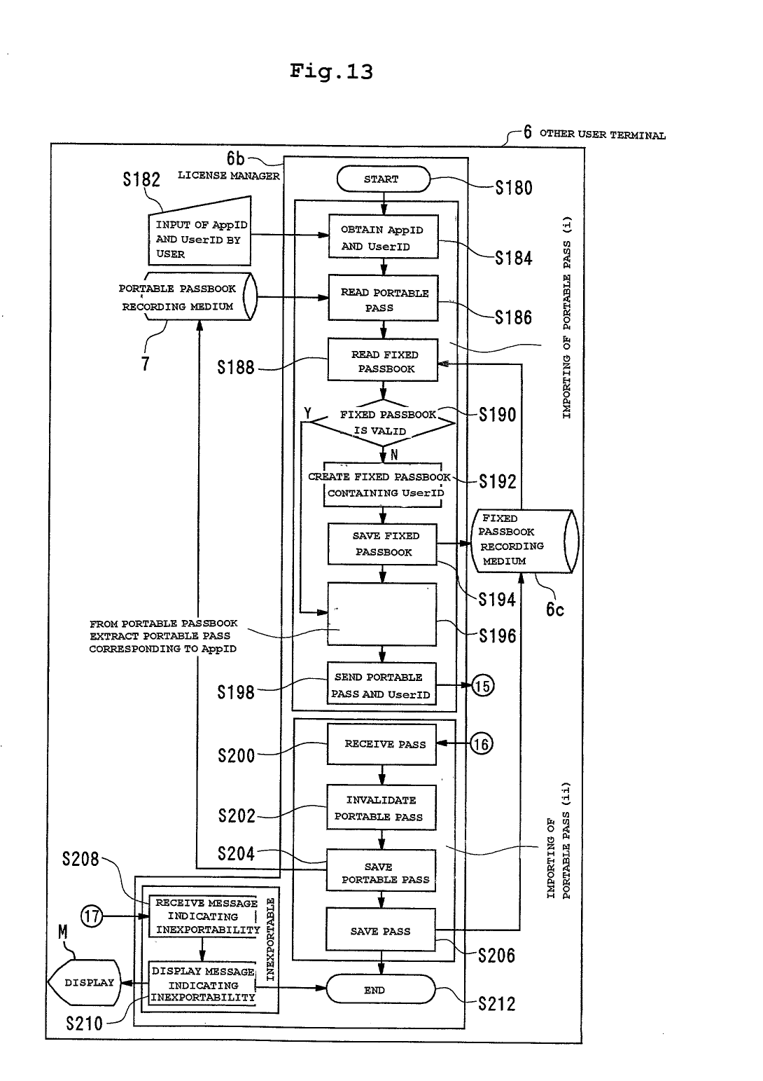

3.4 Importing of the Portable Pass (i) (FIG. 13):

Next, import processing for importing the portable pass “1” saved in the portable passbook recording medium 7 over to the other user terminal 6 is performed. Note that, the other user terminal 6 is provided with a license manager 6b which is the same as the license manager 4b in the user terminal 4, and a CPU acts as a control means to execute the program, whereby the import processing which is explained subsequently is executed.

First, the user boots the license manager 6b at the user terminal 6 (s180). Then, when the application ID “a-1” corresponding to the portable pass “1”, which is the object to be imported and the user ID “3”, are obtained by the user input (s182, s184), the license manager 6b reads the portable pass “1” out from the flexible disk portable passbook recording medium 7 (s186), reads the fixed passbook out from the fixed passbook recording medium 6c which is a hard disk provided to the user terminal 6 (s188), and judges the validity thereof (s190). In this validity judgment, a judgment of “Valid” is made only in the case where the fixed passbook exists in the fixed passbook recording medium 6c and the user ID is contained in the fixed passbook. However, since this is the first time that the user terminal 6 is importing the portable pass, the fixed passbook does not exist in the fixed passbook recording medium 6c. Therefore, the judgment of “Invalid” is made here, and a fixed passbook containing the user ID “3” is created and saved (s192, s194). Next, the license manager 6b extracts the portable pass “1” corresponding to the application ID “a-1” from the portable passbook (s196), and sends the portable passbook “1” and the user ID “3” to the license management server machine 3 (s198).

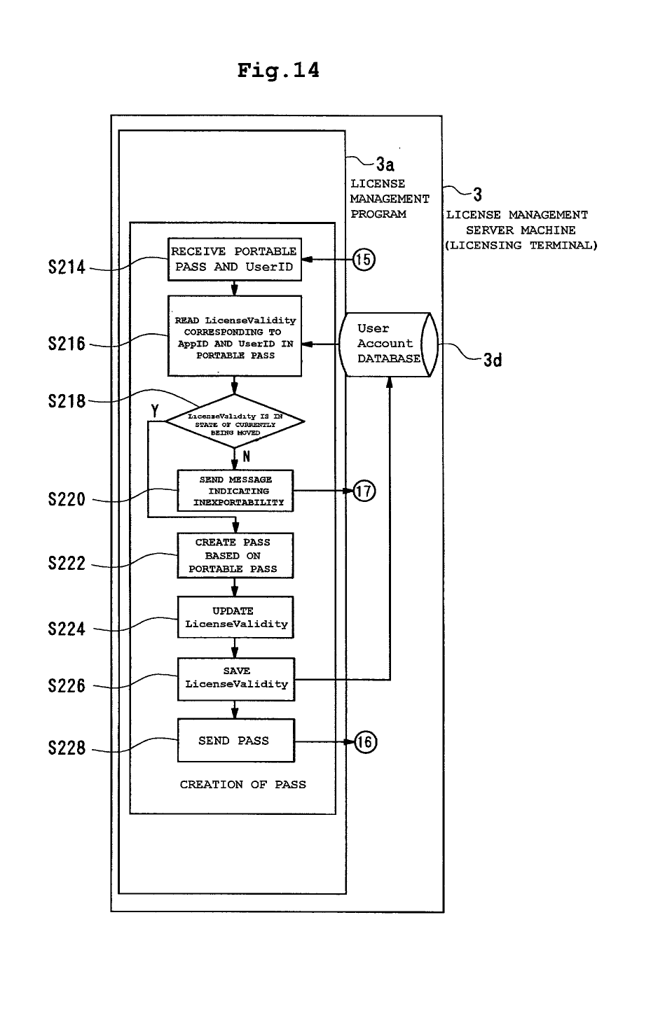

3.5 Creation of the Pass (FIG. 14):

At the license management server machine 3, the license management program 3a reads, from the user account database 3b, the license validity in the license data that corresponds to the application ID “a-1” in the received portable pass “1” and the user ID “3”, which are received (s126), and verifies whether the license validity is in the “Currently Being Moved” state or not (s218). In this judgment, the license validity is judged to be in the “Currently Being Moved” state only in the case when the following three conditions are met: the “remaining amount of the license” contained in the license validity has a value greater than zero, the “license status” has a “Valid” value, and the “pass status” has the “Currently Being Moved” value. Here, for the application ID “a-1”, the “remaining amount of the license” is still unused and indicates “perpetual”, the “license status” is “Valid” and the “pass status” has been updated to the “Currently Being Moved” state at step 174 in FIG. 12; therefore, the license validity is judged to be “Currently Being Moved”. Therefore, the license management program 3a duplicates the “pass status” and the “remaining amount of the pass” in the license validity of the portable pass “1”, and combines these with the application ID “a-1” to make the pass “1” (s222). Next, the license management program 3a replaces the “pass status” in the license validity which has been read out with a value indicating “Valid”, updates the license validity (s224), and saves to the user account database 3b (s226). Further, the pass “1” created at step 222 is sent to the user terminal 6 (s228).

Note that, at the above-mentioned step 218, the judgment was made as to whether the license validity is “Currently Being Moved” or not; however, in the case where the license validity is judged not to be “Currently Being Moved”, a message indicating unimportability is sent to the user terminal 6 (s220), and this message is received by the user terminal (s208) and displayed on the display or other such output device M (s210).

3.6 Importing of the Portable Pass (ii) (FIG. 13):

After the license manager 6b executed by the user terminal 6 receives the pass “1” (s200), it then replaces the “pass status” in the pass validity of the portable pass “1” with the “Invalid” value and invalidates the portable pass (s202). Invalidating the portable pass in this way can prevent the user from using the portable passbook recording medium 7, and, additionally, using the software that corresponds to the application ID “a-1” at the other user terminal. Further, the license manager 6b saves, to the portable passbook recording medium 7, the portable pass “1” in which the “pass status” of the pass validity has been invalidated (s204), and also saves the pass “1” into the fixed passbook recording medium 6c (s206). According to the above processing example, the importing of the portable passbook to the user terminal 6 is finished (s212) and the software corresponding to the application ID “a-1” can be used at the user terminal 6.

4 Modifications of the Embodiment:

In the above embodiment, an example was shown in which the licensing system is connected to each of the terminals via the Internet network which serves as the “communications circuit”; however, this is not intended to limit the licensing system, and the licensing system can be implemented regardless of the category of the configuration of the connection.

Further, in the above embodiment, there was provided the license management server machine 3 for unifying the multiple supplier terminals 1 and 2 and performing centralized collective management of the license; however, it is also possible for each of the supplier terminals 1 and 2 to be provided with a server machine similar to the license management server machine 3, and thus implement the licensing system.

In the above embodiment, an example was shown of a case where the software that is subject to the approval of usage is installed into the user terminal 4 in advance; however, it is also possible that, after the usage approval is obtained according to the above main points, the software for which approval has been received is installed into the user terminal 4.

Additionally, for example, in the above embodiment, before the license controller 4a sends the application ID and the user ID to the license management server machine 3 at steps 40 and 50 of FIG. 7, in order to increase the safety of the system of the present example, these data can first be sent to the license manager 4b and go through a user certification processing performed by manual input by the user, before being sent to the license management server machine 3.

### INDUSTRIAL APPLICABILITY

According to the licensing system of the present invention, it becomes possible to increase the range of the software licensing choices for the user, to thereby meet a variety of needs even with the same single software. Accordingly, it becomes possible to reasonably resolve the problems inherent in the collective licensing of the software, for which much doubts has been voiced conventionally, in a manner which corresponds with the users' needs.

Further, from the perspective of the software supplier, there is the significant merit that even if the software is distributed by means of a CD-ROM, for example, or some other such portable recording medium, the software cannot be used at the user terminal without the pass that is created by the licensing terminal; therefore, illegal copying of the software that has been the subject of doubts conventionally can be eliminated.

What is claimed is:

1. A software licensing system comprising: a licensing terminal for storing a license menu which includes information on a function, a term and a number of times and the like for which usage may be approved for a software that is subject to usage approval; and a user terminal capable of accessing the license menu via a communications line;
wherein when the licensing terminal creates and sends to the user terminal a pass containing information on the function, the term and the number of times and the like for which usage is to be approved based on an agreement/selection by the user terminal, the user terminal then sends, to the software for which usage approval is to be given, a run-approval or a run-disapproval command data according to information on the function, the term and the number of times of use and the like contained in the received pass, and the user terminal then becomes able to use the software according to the content of the usage approval in the pass created by the license terminal.

2. A software licensing system according to claim 1,
wherein the pass given to the user terminal contains a pass status data indicating the current validity of the function, the term and the number of times of use and other such usage approval content, and then in the case where the pass status data of the pass received from the user terminal is “Valid”, the licensing terminal creates and sends to the user terminal a portable pass which contains information on the functions, the term and the number of times and the like for which use has been approved based on the agreement/selection by said user terminal and the pass status data indicating the current validity of this usage approval content, said portable pass being capable of being moving to another user terminal other than said user terminal; and at said other user terminal it is possible, based on the portable pass which has been moved from the first user terminal, to use the same software as the software that has already been used at the first user terminal.

3. A software licensing system according to claim 2,
wherein when the user terminal receives the portable pass, it changes the pass status data of the pass to “Currently Being Moved”, and sends run-prohibition command data to the software which has already been usage-approved to thereby makes the software unusable.

4. A software licensing system according to claim 2 or claim 3,
wherein in the case where the pass status data of the portable pass received from the other user terminal is “Currently Being Moved”, the licensing terminal creates a new pass and sends this to the other user terminal; and the other user terminal sends, to said software, run command data in accordance with information on the function, the term and the number of times of use and the like which was included in the new pass, to thereby make it possible for the other user terminal to use said software.

5. A software licensing system according to claim 4,
wherein when the other user terminal receives the new pass, it changes the pass status data of said portable pass to “Invalid”, to thereby invalidate the portable pass.

6. A software licensing terminal comprising: a means for storing the license menu which includes the function, the term and the number of times and the like for which usage may be approved for the software that is subject to usage approval; a means for creating a pass containing the function, the term and the number of times and the like for which usage is approved based on the agreement/selection by the user terminal that is connected via a communications line; and a means for sending the pass to the user terminal via the communications line.

7. A computer program wherein, by means of a control means of a licensing terminal which can connect via a communications line to the user terminal that uses the software for which usage approval has been given and which stores a license menu containing the function, the term and the number of times and the like for which usage may be approved for said software, said computer program executes the processing for:
(a) sending to the user terminal a license menu that pertains to said software;
(b) receiving agreement/selection data that contains information on the function, the term and the number of times of use and the like that the user terminal agreed/selected from the license menu, and creating the pass that contains information on the function, the usage period and the like for which usage is to be approved for said software, based on said agreement/selection data; and
(c) sending the pass to the user terminal.

8. A user terminal comprising: a means for connecting, via a communications line, to a licensing terminal that stores a licensing menu which includes the function, the term and the number of times and the like for which usage may be approved with respect to the software for which usage approved is to be given; a means for receiving from the licensing terminal a pass containing the function, the term and the number of times of use and the like which were agreed/selected from the license menu; and a means for sending, to said software, run-approval or run-disapproval command data according to information on the function, the term and the number of times of use and the like contained in the received pass.

9. A computer program wherein, by means of a control means of a user terminal that can connect via a communications line to a licensing terminal which stores a license menu containing the function, the term and the number of times and the like for which the usage may be approved regarding said software to be usage-approved, said computer program executes the processing for:
(a) creating the agreement/selection data that contains information on the function, the term and the number of times of use and the like which were agreed/selected from the license menu; and
(b) receiving from the licensing terminal a pass which contains the function, the usage period and the like for which usage was approved for said software based on said agreement/selection data and sending, to said software, a run-approval or run-disapproval command data in accordance with information on the function, the term and the number of times of use and the like contained in the received pass.
